(19) United States
(12) Patent Application Publication
(10) Pub. No.: US 2026/0281841 A1
(43) Pub. Date: Sep. 17, 2026

(54) CELL RESELECTION METHODS AND APPARATUSES, COMMUNICATION APPARATUS AND STORAGE MEDIUM

(71) Applicant: BEIJING XIAOMI MOBILE SOFTWARE CO., LTD., Beijing (CN)

(72) Inventors: Xiaofei LIU, Beijing (CN); Xiaowei JIANG, Beijing (CN)

(21) Appl. No.: 19/469,229

(22) PCT Filed: Mar. 29, 2023
(86) PCT No.: PCT/CN2023/084890

§ 371 Date: Sep. 25, 2025

(51) Int. Cl. H04W 36/00

(52) U.S. Cl. CPC H04W 36/00835; H04W 36/0085

(57) ABSTRACT

A method for cell reselection, including: performing the cell reselection according to first slice information corresponding to mobile originated (MO) traffic.

### CROSS-REFERENCE TO RELATED APPLICATIONS

The present application is a U.S. National Stage of International Application No. PCT/CN 2023/084890, filed on Mar. 29, 2023, the contents of all of which are incorporated herein by reference in their entirety for all purposes.

### BACKGROUND OF THE INVENTION

A network slice (NS) can provide one complete end-to-end virtual network for specific users. By dividing a network resource into a plurality of network slices, the network slices can provide differentiated services for users with different service requirements (including delay, reliability, capacity, isolation, and other functions).

### SUMMARY OF THE INVENTION

The present disclosure relates to the technical field of communication, and in particular, to a method for cell reselection, a method and device for cell reselection, a communication system, a communication device, and a computer-readable storage medium. Embodiments of the present disclosure provide a method for cell reselection, a method and device for cell reselection, a communication system, a communication device, and a computer-readable storage medium to solve technical problems in the related art.

According to a first aspect of the embodiments of the present disclosure, a method for cell reselection is provided. The method is performed by a terminal. The method includes: performing the cell reselection according to first slice information corresponding to mobile originated (MO) traffic.

According to a second aspect of the embodiments of the present disclosure, a method for cell reselection is provided. The method is performed by a network device. The method includes: sending second slice information to a terminal, where the second slice information is configured for the terminal to determine first slice information corresponding to mobile originated traffic, and performing the cell reselection according to the first slice information.

According to a third aspect of the embodiments of the present disclosure, a communication device is provided. The communication device includes: one or more processors; and a memory configured to store a computer program. The computer program, when collectively executed by the one or more processors, causes the communication device to: perform the cell reselection according to first slice information corresponding to mobile originated traffic.

According to a fourth aspect of the embodiments of the present disclosure, a non-transitory computer-readable storage medium is provided. The non-transitory computer-readable storage medium is configured to store a computer program. The computer program, when collectively executed by one or more processors, implements the method for cell reselection performed by a terminal.

### BRIEF DESCRIPTION OF DRAWINGS

To describe technical solutions in embodiments of the present disclosure more clearly, the accompanying drawings required for describing the embodiments are briefly introduced below. Obviously, the accompanying drawings in the following description show merely some embodiments of the present disclosure, and those of ordinary skill in the art can derive other accompanying drawings from these accompanying drawings without creative efforts.

FIG. 1 is a schematic diagram of an application scenario according to an embodiment of the present disclosure;

FIG. 2 is a schematic flowchart of a method for cell reselection according to an embodiment of the present disclosure;

FIG. 3 is a schematic flowchart of a method for cell reselection according to another embodiment of the present disclosure;

FIG. 4 is a schematic flowchart of a method for cell reselection according to yet another embodiment of the present disclosure;

FIG. 5 is a schematic flowchart of a method for cell reselection according to still another embodiment of the present disclosure;

FIG. 6 is a schematic flowchart of a method for cell reselection according to an embodiment of the present disclosure;

FIG. 7 is a schematic flowchart of a method for cell reselection according to another embodiment of the present disclosure;

FIG. 8 is a schematic block diagram of a device for cell reselection according to an embodiment of the present disclosure;

FIG. 9 is a schematic block diagram of a device for cell reselection according to an embodiment of the present disclosure;

FIG. 10 is a schematic block diagram of a device for cell reselection according to an embodiment of the present disclosure; and

FIG. 11 is a schematic block diagram of a device for cell reselection according to an embodiment of the present disclosure.

### DETAILED DESCRIPTION OF THE INVENTION

Implementations or embodiments of the present disclosure are not exhaustive, are illustrative of some implementations or embodiments, and are not regarded as specific limitations on the protection scope of the present disclosure. In a case of no contradiction, each step in an implementation or embodiment can be implemented as an independent embodiment, and all the steps can be arbitrarily combined. For example, a solution subjected to removal of some steps from an implementation or embodiment can be implemented as an independent embodiment, and a sequence of all steps in an implementation or embodiment can be arbitrarily changed. In addition, optional modes or optional instances in an implementation or embodiment can be arbitrarily combined. In addition, all the implementations or embodiments can be arbitrarily combined. For example, some or all steps of different implementations or embodiments can be arbitrarily combined, and an implementation or embodiment can be arbitrarily combined with optional modes or optional instances of other implementations or embodiments.

In some implementations or embodiments, “in a case where,” “in a case that,” “at the time when,” “when,” and “if” in the present disclosure are interchangeable with each other.

In some implementations or embodiments, descriptions such as “A or B,” “A and/or B,” “at least one of A and B,” “in one case A, in another case B” and “in response to one case A, in response to another case B” of the present disclosure may include, according to cases, at least one of the following technical solutions: A, that is, A in some implementations or embodiments, is performed independently of B; B, that is, B in some implementations or embodiments, is performed independently of A; A and B are selectively performed, that is, A and B in some implementations or embodiments are selected to be performed; or both A and B, that is, A and B in some implementations or embodiments, are performed.

In some implementations or embodiments, “include A,” “contain A,” “configured to indicate A,” and “carry A” in the present disclosure can be interpreted as directly carrying A or indirectly indicating A.

In addition, each element, each row, or each column in the table related to the present disclosure can be implemented as an independent embodiment, and a combination of any element, any row, or any column can be implemented as an independent embodiment.

A network slice (NS) can provide one complete end-to-end virtual network for specific users. By dividing a network resource into a plurality of network slices, the network slices can provide differentiated services for users with different service requirements (including delay, reliability, capacity, isolation, and other functions).

Operator networks can not only support information-consumption services whose communication requirement is characterized by best-effort transmission, but also meet production-control services that request deterministic transmission, by allocating network resources that are logically or physically isolated for services with differing communication requirements.

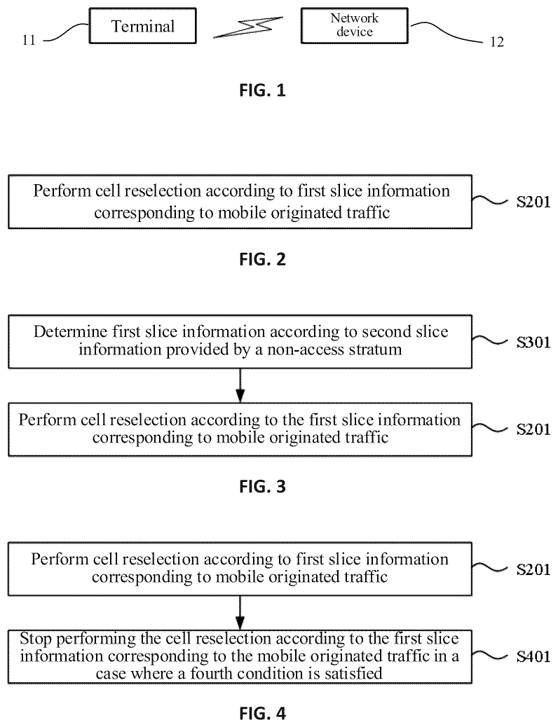

FIG. 1 is a schematic diagram of an application scenario according to an embodiment of the present disclosure.

As shown in FIG. 1, the embodiment of the present disclosure may be applied to a scenario where a terminal is in communication with a network device, and is not limited to the scenario. All main bodies shown in FIG. 1 are illustrative. An implementation or embodiment of the present disclosure may include all or some main bodies in FIG. 1, or may include main bodies other than those in FIG. 1. A quantity of main bodies is arbitrary and is not limited to that in FIG. 1. Each connection relationship shown in FIG. 1 is illustrative, and any main bodies may be connected in any manner or not, which may be directly or indirectly connected, or connected in a wired or wireless manner.

In an embodiment, as shown in FIG. 1, the terminal 11 includes, but is not limited to, a mobile phone, a tablet computer, a wearable device, a sensor, an Internet of Things device, or other communication devices/apparatuses. The terminal 11 may be in communication with the network device 12. The network device 12 includes, but is not limited to, a network device in a communication system of 4th generation mobile communication technology (4G), 5G, or 6G, such as a base station and a core network device.

In an embodiment, a network slice (referred to as a slice below) consists of a radio access network (RAN) part and a core network (CN) device part. Implementation of the slice depends on a principle that traffic of different slices is processed by different protocol data unit (PDU) sessions. The network device 12 may implement different slices by scheduling and providing different layer 1 (L1)/layer 2 (L2) configurations.

In an embodiment, each slice is uniquely identified by single-network slice selection assistance information (S-NSSAI). The S-NSSAI is composed of a slice/service type (SST) and a slice differentiator (SD). Network slice selection assistance information (NSSAI) may include one or more S-NSSAIs.

In an embodiment, in a case where the terminal is in an idle state or an inactive state, it may perform cell reselection to camp on a cell with a higher priority or better signal quality.

In an embodiment, the base station may provide frequency point priority of the cell reselection through a system information block (SIB) or a radio resource control (RRC) message (for example, an RRC release message). The terminal may determine a frequency point with the highest priority and a cell with the best signal quality at the frequency point according to a related criterion of the cell reselection, and then reselect the cell to obtain a better communication service.

In an embodiment, in a case of introducing a slice, the terminal performs the cell reselection, which may be slice-based cell reselection. In this case, a non-access stratum (NAS) of the terminal may provide the S-NSSAI, network slice access-stratum group (NSAG) information (for example, a mapping relationship between an S-NSSAI and an NSAG, tracking area (TA) information associated with the NSAG, etc.), a NSAG priority, and frequency point priority corresponding to the NSAG broadcast by the network device for an access stratum (AS). The AS may determine reselection priority (for example, NSAG priority, frequency point priority, cell priority, etc.) of the slice-based cell reselection according to content provided by the NAS and then perform the cell reselection based on the reselection priority.

In an embodiment, the S-NSSAI provided by the NAS for the AS may include at least one of the following: allowed NSSAI or requested NSSAI. The cell reselection may be triggered, in a case where a slice corresponding to a service that the terminal needs to perform includes a slice other than the allowed NSSAI, and, for example, the terminal requests a slice other than the allowed NSSAI. It should be noted that a triggering condition of the cell reselection in the implementation of the present disclosure is not limited here, and may be applied to scenarios where any condition triggers the cell reselection. For example, the scenario may be a scenario where one or more partial allowed S-NSSAI trigger the cell reselection, or a scenario where one or more alternative S-NSSAI trigger the cell reselection.

In an embodiment, the terminal may determine an NSAG to which a requested slice belongs. For example, in a case where the NSAG is referred to as a first NSAG, a frequency point priority may be determined based on at least one of the following modes.

The priority of a frequency point supporting the first NSAG is higher than the priority of a frequency point not supporting the first NSAG.

The priority of a frequency point supporting a high priority NSAG is higher than the priority of a frequency point supporting a low priority NSAG.

The priorities of a plurality of frequency points supporting the same NSAG are determined according to the frequency point priorities corresponding to the NSAG provided by the network device.

Or, the priorities of a plurality of frequency points not supporting an NSAG are determined according to legacy frequency point priorities.

In an embodiment, the terminal may perform the cell reselection according to the determined frequency point priority. In a case where a cell with the best signal quality in cells corresponding to a frequency point does not support the NSAG corresponding to the frequency point, reselection priority is re-determined according to an NSAG actually supported by the cell with the best signal quality.

According to the embodiments, the terminal may preferentially reselect a frequency point and a cell that supports the high priority NSAG. However, in some cases, a cell only supports the high priority NSAG, the terminal is camped on the cell, and a slice corresponding to mobile originated (MO) traffic does not belong to the high priority NSAG, and, for example, belongs to a lower priority NSAG. In this case, a PDU session cannot be established because the cell on which the terminal is camped does not support the slice corresponding to the mobile originated traffic.

FIG. 2 is a schematic flowchart of a method for cell reselection according to an embodiment of the present disclosure. The method for cell reselection shown in the embodiment may be performed by a terminal.

As shown in FIG. 2, the method for cell reselection may include the following step S201.

In step S201, the cell reselection is performed according to first slice information corresponding to mobile originated (MO) traffic.

In an embodiment, when the terminal performs the cell reselection, the terminal may perform the cell reselection according to the first slice information corresponding to the MO traffic. Thus, a cell supporting the first slice information corresponding to the MO traffic is preferentially reselected to ensure that the cell can support the first slice information corresponding to the MO traffic in a case where the terminal is camped on the reselected cell. In this way, the smooth operation of the MO traffic is ensured.

In an embodiment, performing the cell reselection according to the first slice information corresponding to the mobile originated traffic includes: performing the cell reselection according to the first slice information corresponding to the mobile originated traffic, in a case where a first condition is satisfied.

Before the terminal performs the cell reselection according to the first slice information corresponding to the MO traffic, the terminal may determine whether the first condition is satisfied. In a case where the first condition is satisfied, the cell reselection is performed according to the first slice information corresponding to the MO traffic. In a case where the first condition is not satisfied, the cell reselection does not need to be performed according to the first slice information corresponding to the MO traffic. In this way, control of performing the cell reselection according to the first slice information corresponding to the MO traffic is facilitated.

In an embodiment, the first condition includes at least one of the following: a current serving cell not supporting the first slice information; a measurement result for a frequency point supporting the first slice information; or a measurement result for a cell supporting the first slice information.

It should be noted that the measurement result in the embodiment of the present disclosure may include an available measurement result.

The three first conditions are illustrated through a plurality of embodiments, and first conditions suitable for the embodiment of the present disclosure are not limited to the above three first conditions.

In an embodiment, the terminal may determine whether a current cell (for example, a cell on which the terminal is currently camped) supports the first slice information corresponding to the MO traffic.

For example, in a case where the current cell supports the first slice information, the cell reselection is not performed according to the first slice information corresponding to the MO traffic, rather, communication in the current cell can ensure smooth operation of the MO traffic.

For example, in a case where the current cell does not support the first slice information, the cell reselection may be performed according to the first slice information corresponding to the MO traffic, to reselect to the cell that supports the first slice information corresponding to the MO traffic. In this way, in a case where the terminal is camped on the reselected cell, it can ensure that the cell supports the first slice information corresponding to the MO traffic, to proceed the MO traffic smoothly.

In an embodiment, the terminal may determine whether there is the measurement result for the frequency point supporting the first slice information; and/or whether there is the measurement result for the cell supporting the first slice information.

For example, in a case where the terminal has the measurement result for the frequency point supporting the first slice information and the measurement result for the cell supporting the first slice information, the cell reselection may be performed according to the first slice information corresponding to the MO traffic. In this way, the measurement results can be applied appropriately, helping to avoid wasting the measurement results.

For example, in a case where the terminal has no measurement result for the frequency point supporting the first slice information or no measurement result for the cell supporting the first slice information, the cell reselection may not be performed according to the first slice information corresponding to the MO traffic. In this way, excessive overhead that would otherwise be incurred by obtaining measurement results for frequency points and cells supporting the first slice information can be avoided.

It should be noted that the terminal may perform the cell reselection according to the first slice information corresponding to the MO traffic in a case where there is a measurement result for the frequency point supporting the first slice information, but no measurement result for the cell supporting the first slice information. Or, the terminal may perform the cell reselection according to the first slice information corresponding to the MO traffic in a case where there is a measurement result for the cell supporting the first slice information, but no measurement result for the frequency point supporting the first slice information. The details may be selected as required, and are not limited by the present disclosure here.

In an embodiment, the terminal may determine whether the current cell supports the first slice information corresponding to the MO traffic, or determine whether there is the measurement result for the frequency point and/or cell supporting the first slice information.

For example, in a case where the current serving cell supports the first slice information, while the terminal does not have a measurement result for the frequency point supporting the first slice information and does not have a measurement result for the cell supporting the first slice information, the cell reselection may not be performed according to the first slice information corresponding to the MO traffic. In this way, excessive overhead that would otherwise be incurred by obtaining measurement results for frequency points and cells supporting the first slice information can be avoided.

For example, in a case where the current serving cell supports the first slice information, while the terminal has the measurement result for the frequency point supporting the first slice information and has the measurement result for the cell supporting the first slice information, cell reselection may be performed according to the first slice information corresponding to the MO traffic. In this way, the measurement results can be applied appropriately, helping to avoid wasting the measurement results.

For example, in a case where the current serving cell supports the first slice information, while the terminal has the measurement result for the frequency point supporting the first slice information and the measurement result for the cell supporting the first slice information, the cell reselection may not be performed according to the first slice information corresponding to the MO traffic. Since the communication in the current cell can ensure that the MO traffic proceeds smoothly, the cell reselection is not performed according to the first slice information corresponding to the MO traffic, which is conducive to a reduction in the overhead of the terminal.

It should be noted that the current serving cell supports the first slice information, and the terminal has the measurement result for the frequency point supporting the first slice information and the measurement result for the cell supporting the first slice information. Whether to perform the cell reselection according to the first slice information corresponding to the MO traffic may be determined based on a protocol agreement or an indication of the network device, or implemented based on the terminal.

For example, in a case where the current serving cell does not support the first slice information, and the terminal does not have a measurement result for the frequency point supporting the first slice information, or does not have a measurement result for the cell supporting the first slice information, the cell reselection may be performed according to the first slice information corresponding to the MO traffic, to reselect to the cell that supports the first slice information corresponding to the MO traffic. In this way, in a case where the terminal is camped on the reselected cell, it can ensure that the cell supports the first slice information corresponding to the MO traffic, to proceed the MO traffic smoothly.

For example, the current serving cell does not support the first slice information, and the terminal does not have a measurement result for the frequency point supporting the first slice information, nor does it have a measurement result for the cell supporting the first slice information. In this case, the cell reselection may not be performed according to the first slice information corresponding to the MO traffic. In addition, the current serving cell is accessed. After a connected state is entered, cell switching is performed based on a notification of the network device, and the cell supporting the first slice information corresponding to the MO traffic is switched to. Thus, it is ensured that the cell can support the first slice information corresponding to the MO traffic in a case where the terminal is camped on the cell obtained through switching. In this way, the smooth operation of the MO traffic can be ensured.

For example, the current serving cell does not support the first slice information. The terminal has the measurement result for the frequency point supporting the first slice information and the measurement result for the cell supporting the first slice information. In this case, the cell reselection may be performed according to the first slice information corresponding to the MO traffic. Thus, the cell supporting the first slice information corresponding to the MO traffic is reselected to ensure that the cell can support the first slice information corresponding to the MO traffic in a case where the terminal is camped on the reselected cell. In this way, smooth operation of the MO traffic can be ensured. In addition, the measurement results can be applied appropriately, helping to avoid wasting the measurement results.

For example, the current serving cell does not support the first slice information. The terminal has the measurement result for the frequency point supporting the first slice information or the measurement result for the cell supporting the first slice information. In this case, the cell reselection may be performed according to the first slice information corresponding to the MO traffic. Thus, the cell supporting the first slice information corresponding to the MO traffic is reselected to ensure that the cell can support the first slice information corresponding to the MO traffic in a case where the terminal is camped on the reselected cell. In this way, smooth operation of the MO traffic can be ensured. In addition, the measurement results can be applied appropriately, helping to avoid wasting the measurement results.

The descriptions of the frequency point that supports the first slice information and the cell that supports the first slice information are illustrated below through a plurality of embodiments.

In an embodiment, the first slice information includes at least one of the following: a network slice access-stratum group corresponding to the mobile originated traffic; a priority of the network slice access-stratum group; or tracking area (TA) information of the network slice access-stratum group.

In an embodiment, the method for cell reselection further includes: determining that the frequency point supports the first slice information, in a case where the frequency point satisfies a second condition. The second condition includes at least one of the following: the frequency point has a capability to support the first slice information; or the frequency point has an available radio resource, and the radio resource is capable of supporting a quality of service (QoS) requirement of a protocol data unit (PDU) session associated with the first slice information.

In an embodiment, the first slice information may include the NSAG corresponding to the MO traffic, the priority of the NSAG, the TA information of the NSAG, etc. The frequency point has the capability to support the first slice information, which may include the case where the frequency point supports at least one of the NSAG corresponding to the MO traffic, the priority of the NSAG, or the TA information of the NSAG.

For example, in a case where the frequency point has the capability to support the first slice information, it may be determined that the frequency point supports the first slice information.

For example, in a case where the frequency point has the available radio resource and the radio resource is capable of supporting the QoS requirement of the PDU session associated with the first slice information, it may be determined that the frequency point supports the first slice information.

For example, in a case where the frequency point has the capability to support the first slice information, and the frequency point has the available radio resource and the radio resource is capable of supporting the QoS requirement of the PDU session associated with the first slice information, it may be determined that the frequency point supports the first slice information.

In an embodiment, the method for cell reselection further includes: determining that the cell supports the first slice information, in a case where the cell satisfies a third condition. The third condition includes at least one of the following: the cell has a capability to support the first slice information; or the cell has an available radio resource, and the radio resource is capable of supporting a quality of service requirement of a protocol data unit session associated with the first slice information.

In an embodiment, the first slice information may include the NSAG corresponding to the MO traffic, the priority of the NSAG, the TA information of the NSAG, etc. The cell has the capability to support the first slice information, which may include the case where the cell supports at least one of the NSAG corresponding to the MO traffic, the priority of the NSAG, or the TA information of the NSAG.

For example, in a case where the cell has the capability to support the first slice information, it may be determined that the cell supports the first slice information.

For example, in a case where the cell has the available radio resource and the radio resource is capable of supporting the QoS requirement of the PDU session associated with the first slice information, it may be determined that the cell supports the first slice information.

For example, in a case where the cell has the capability to support the first slice information, and the cell has the available radio resource and the radio resource is capable of supporting the QoS requirement of the PDU session associated with the first slice information, it may be determined that the cell supports the first slice information.

FIG. 3 is a schematic flowchart of a method for cell reselection according to another embodiment of the present disclosure. The method for cell reselection may be performed by a terminal. As shown in FIG. 3, the method for cell reselection further includes the following step S301.

In step S301, first slice information is determined according to second slice information provided by a non-access stratum.

It should be noted that the embodiment shown in FIG. 3 may be implemented independently or in combination with at least one other embodiment in the present disclosure, which may be selected as required and not limited by the present disclosure.

In an embodiment, the first slice information may include an NSAG corresponding to MO traffic, a priority of the NSAG, TA information of the NSAG, etc. An AS may determine the first slice information according to the second slice information provided by the NAS.

The NAS may determine the second slice information based on a predefined rule (for example, a protocol agreement) or by receiving NAS signaling (for example, sent by a core network device). For example, the NAS may determine a correspondence relationship between a service and an S-NSSAI according to a user equipment route selection policy (URSP) configured by the NAS signaling, determine S-NSSAI corresponding to the MO traffic according to the correspondence relationship, and then determine the second slice information accordingly.

It should be noted that the S-NSSAI corresponding to the MO traffic belongs to at least one of the following: allowed NSSAI, alternative S-NSSAI, or partial allowed S-NSSAI. In a case of resource shortage of the S-NSSAI currently carrying the MO traffic, the S-NSSAI currently carrying the MO traffic may be replaced with the alternative S-NSSAI. The partial allowed S-NSSAI refers to the S-NSSAI that is not uniformly supported in a range of a registration area (RA) and is only supported in some TAs in the RA. Existing allowed NSSAI is S-NSSAI supported by all TAs in the RA.

In an embodiment, the second slice information includes at least one of the following: at least one single-network slice selection assistance information (S-NSSAI) corresponding to the mobile originated traffic; information related to a network slice access-stratum group (NSAG); or validity information.

In an embodiment, the information related to the NSAG includes at least one of the following: information related to the NSAG to which the allowed NSSAI belongs, information related to the NSAG to which the alternative S-NSSAI belongs, or information related to the NSAG to which the partial allowed S-NSSAI belongs.

In an embodiment, the information related to the network slice access-stratum group includes at least one of the following: a mapping relationship between the single-network slice selection assistance information and the network slice access-stratum group; or the priority of the network slice access-stratum group.

In an embodiment, after determining the S-NSSAI corresponding to the MO traffic, the NAS may determine an NSAG to which the S-NSSAI belongs according to the mapping relationship between the S-NSSAI and the NSAG, and then determine the priority of the NSAG. For example, the priority of the NSAG to which the S-NSSAI belongs may be determined according to a protocol agreement or the priority of a plurality of NSAGs indicated by the network device.

In an embodiment, the validity information includes at least one of the following: validity area information of the single-network slice selection assistance information; validity time information of the single-network slice selection assistance information; validity area information of the information related to the network slice access-stratum group; or validity time information of the information related to the network slice access-stratum group.

After determining the S-NSSAI corresponding to the MO traffic and the NSAG to which the S-NSSAI belongs, the NAS may determine validity information of the S-NSSAI and validity information of the NSAG. For example, the validity information of the S-NSSAI corresponding to the MO traffic may be determined according to the protocol agreement or the validity information of a plurality of S-NSSAI indicated by the network device. For example, the validity information of the NSAG to which the S-NSSAI belongs may be determined according to the protocol agreement or the validity information of the plurality of NSAGs indicated by the network device.

The validity information may include validity time or the validity area information. However, the validity information is not limited to the above two types, and is not limited by the present disclosure.

In an embodiment, performing the cell reselection according to the first slice information corresponding to the mobile originated traffic includes at least one of the following:
determining a reselection priority of the cell reselection according to the first slice information corresponding to the mobile originated traffic;
determining a candidate cell of the cell reselection according to the first slice information corresponding to the mobile originated traffic; or
determining a target cell of the cell reselection according to the first slice information corresponding to the mobile originated traffic.

In an embodiment, the cell reselection may include the steps of determining the reselection priority of the cell reselection, determining the candidate cell of the cell reselection, determining the target cell of the cell reselection, or other steps.

In a case where the cell reselection is performed according to the first slice information corresponding to the MO traffic, determining the reselection priority of the cell reselection may be determining the reselection priority of the cell reselection according to the first slice information corresponding to the MO traffic, determining the candidate cell of the cell reselection may be determining the candidate cell of the cell reselection according to the first slice information corresponding to the MO traffic, and determining the target cell of the cell reselection may be determining the target cell of the cell reselection according to the first slice information corresponding to the MO traffic. In this way, it can be ensured that the steps involved in the cell reselection take into account the first slice information corresponding to the MO traffic. Further, a reselection result can be a preferentially reselected cell supporting the first slice information corresponding to the MO traffic, so as to ensure that the cell may support the first slice information corresponding to the MO traffic in a case where the terminal is camped on the reselected cell. In this way, smooth operation of the MO traffic is ensured.

In an embodiment, determining the reselection priority of the cell reselection according to the first slice information corresponding to the mobile originated traffic includes at least one of the following:
determining that a priority of a first frequency point is higher than a priority of a second frequency point, where the first frequency point is a frequency point that supports the first slice information, and the second frequency point is a frequency point that does not support the first slice information; or
determining that a priority of a first cell is higher than a priority of a second cell, where the first cell is a cell that supports the first slice information, and the second cell is a cell that does not support the first slice information.

It should be noted that in a case where a frequency point is determined as the first frequency point supporting the first slice information of the MO traffic, the terminal may improve the priority of the first frequency point. For example, the priority of the first frequency point is improved to the highest level, or improved by one or more levels, and the cell reselection is performed based on the improved priority. In a case where a cell is determined as the first cell supporting the first slice information of the MO traffic, the terminal may improve the priority of the first cell. For example, the priority of the first cell is improved to the highest level, or improved by one or more levels, and the cell reselection is performed based on the improved priority.

In an embodiment, the reselection priority of the cell reselection may include frequency point priority. In this case, determining the reselection priority of the cell reselection according to the first slice information corresponding to the MO traffic may include determining the frequency point priority according to the first slice information corresponding to the MO traffic.

For example, it may be determined that the priority of the first frequency point supporting the first slice information is higher than the priority of the second frequency point not supporting the first slice information. In this way, in a case where the cell reselection is performed according to the first slice information corresponding to the MO traffic, the first frequency point supporting the first slice information corresponding to the MO traffic is preferentially reselected (for example, all cells corresponding to the first frequency point support the first slice information corresponding to the MO traffic), and then the cell supporting the first slice information corresponding to the MO traffic is reselected.

In an embodiment, the reselection priority of the cell reselection may include cell priority. Determining the reselection priority of the cell reselection according to the first slice information corresponding to the MO traffic may include determining the cell priority according to the first slice information corresponding to the MO traffic.

For example, it may be determined that the priority of the first cell supporting the first slice information is higher than the priority of the second cell not supporting the first slice information. In this way, in a case where the cell reselection is performed according to the first slice information corresponding to the MO traffic, the cell supporting the first slice information corresponding to the MO traffic is preferentially reselected.

In an embodiment, performing the cell reselection according to the first slice information corresponding to the mobile originated traffic includes at least one of the following:
determining that the priority of the first frequency point is higher than the priority of a third frequency point and the priority of the third frequency point is higher than the priority of a fourth frequency point, where the first frequency point is a frequency point that supports the first slice information, the second frequency point is a frequency point that does not support the first slice information but does support allowed single-network slice selection assistance information and/or requested single-network slice selection assistance information, and the third frequency point is a frequency point that does not support a slice; or
determining that the priority of the first cell is higher than the priority of a third cell and the priority of the third cell is higher than the priority of a fourth cell, where the first cell is a cell that supports the first slice information, the second cell is a cell that does not support the first slice information and supports allowed single-network slice selection assistance information and/or requested single-network slice selection assistance information, and the third cell is a cell that does not support a slice.

In an embodiment, the reselection priority of the cell reselection may include frequency point priority. In this case, determining the reselection priority of the cell reselection according to the first slice information corresponding to the MO traffic may include determining the frequency point priority according to the first slice information corresponding to the MO traffic.

For example, it may be determined that the priority of the first frequency point supporting the first slice information is higher than the priority of the third frequency point that does not support the first slice information but does support the allowed NSSAI and/or the requested NSSAI, and the priority of the third frequency point is higher than the priority of the fourth frequency point not supporting the slice. In this way, in a case where the cell reselection is performed according to the first slice information corresponding to the MO traffic, the first frequency point supporting the first slice information corresponding to the MO traffic is preferentially reselected (for example, all cells corresponding to the first frequency point support the first slice information corresponding to the MO traffic), and then the cell supporting the first slice information corresponding to the MO traffic is reselected. Even if the first frequency point supporting the first slice information corresponding to the MO traffic fails to be reselected, the third frequency point supporting the allowed NSSAI and/or the requested NSSAI may be preferentially reselected, to ensure that the reselected frequency point can provide services corresponding to the allowed NSSAI and/or the requested NSSAI for the terminal.

In an embodiment, the reselection priority of the cell reselection may include the cell priority. Determining the reselection priority of the cell reselection according to the first slice information corresponding to the MO traffic may include determining the cell priority according to the first slice information corresponding to the MO traffic.

For example, it may be determined that the priority of the first cell supporting the first slice information is higher than the priority of the third cell that does not support the first slice information but does support the allowed NSSAI and/or the requested NSSAI, and the priority of the third cell is higher than the priority of the fourth cell not supporting the slice. In this way, in a case where the cell reselection is performed according to the first slice information corresponding to the MO traffic, the cell supporting the first slice information corresponding to the MO traffic is preferentially reselected. Even if the first cell supporting the first slice information corresponding to the MO traffic fails to be reselected, the third cell supporting the allowed NSSAI and/or the requested NSSAI may be preferentially reselected, to ensure that the reselected cell can provide services corresponding to the allowed NSSAI and/or the requested NSSAI for the terminal.

In an embodiment, determining the candidate cell of the cell reselection according to the first slice information corresponding to the mobile originated traffic includes at least one of the following: determining a first frequency point as a candidate frequency point of the cell reselection, where the first frequency point is a frequency point that supports the first slice information; or determining a first cell as the candidate cell of the cell reselection, where the first cell is a cell that supports the first slice information.

In an embodiment, the cell reselection may include the steps of determining the reselection priority of the cell reselection, determining the candidate cell of the cell reselection, determining the target cell of the cell reselection, or other steps.

In a case where the cell reselection is performed according to the first slice information corresponding to the MO traffic, determining the candidate cell of the cell reselection may include determining the first frequency point supporting the first slice information as the candidate frequency point of the cell reselection, or determining the first cell supporting the first slice information as the candidate cell of the cell reselection.

In this way, it can be ensured that in a case where the candidate cell of the cell reselection is determined, the candidate frequency point supports the first slice information, and the candidate cell supports the first slice information. Further, it is ensured that the cell supporting the first slice information corresponding to the MO traffic is preferentially reselected to ensure that the cell may support the first slice information corresponding to the MO traffic in a case where the terminal is camped on the reselected cell. As a result, smooth operation of the MO traffic is ensured.

In some embodiments, a frequency point/cell supporting slice information corresponding to the MO traffic is determined as a frequency point having the highest priority according to the slice information corresponding to the MO traffic. In a case where there are a plurality of frequency points, it is determined according to frequency point priority specific to a slice sent by a base station or implemented based on the terminal. Optionally, the priority of other frequency points not supporting the slice information corresponding to the MO traffic may be determined according to existing frequency point priority determined based on the allowed NSSAI or the requested NSSAI.

In a case where the reselection priority is determined, only the frequency point/cell supporting the slice information corresponding to the MO traffic may be considered, while the frequency point/cell not supporting the slice information corresponding to the MO traffic is not considered.

Or, a frequency point/cell not supporting the slice information corresponding to the MO traffic may be considered.

In a case where the frequency point/cell supporting the slice information corresponding to the MO traffic is considered, the priority of the frequency point/cell supporting the slice information corresponding to the MO traffic is higher than the priority of the frequency point/cell that does not support the slice information corresponding to the MO traffic but does support the slice information corresponding to the allowed NSSAI/requested NSSAI, and further is higher than the priority of the frequency point/cell not supporting the slice.

In an embodiment, determining the target cell of the cell reselection according to the first slice information corresponding to the mobile originated traffic includes at least one of the following: determining a first frequency point as a target frequency point of the cell reselection, where the first frequency point is a frequency point that supports the first slice information; or determining a first cell as the target cell of the cell reselection, where the first cell is a cell that supports the first slice information.

In an embodiment, the cell reselection may include determining the reselection priority of the cell reselection, determining the candidate cell of the cell reselection, determining the target cell of the cell reselection, or other steps.

Determining the target cell of the cell reselection may include two steps. The first step is determining the target frequency point, and the second step is determining the target cell from the cells corresponding to the target frequency point.

According to the embodiment, in a case where the cell reselection is performed according to the first slice information corresponding to the MO traffic, determining the target frequency point may include determining the frequency point supporting the first slice information as the target frequency point of the cell reselection. Since the cell corresponding to the frequency point supporting the first slice information supports the first slice information, it can be ensured that the cell supporting the first slice information corresponding to the MO traffic is reselected in a case where the candidate cell of the cell reselection is determined. In this way, it is ensured that the cell can support the first slice information corresponding to the MO traffic in a case where the terminal is camped on the reselected cell. As a result, the smooth operation of the MO traffic is ensured.

According to the embodiment, in a case where the cell reselection is performed according to the first slice information corresponding to the MO traffic, determining the target cell of the cell reselection may include: determining the cell supporting the first slice information as the target cell of the cell reselection. In this way, it can be ensured that the cell supporting the first slice information corresponding to the MO traffic is reselected in a case where the candidate cell of the cell reselection is determined, to ensure that the cell can support the first slice information corresponding to the MO traffic in a case where the terminal is camped on the reselected cell. As a result, smooth operation of the MO traffic is ensured.

In an embodiment, in a case where the target cell is determined, in addition to determination conditions (such as an R criterion and/or an S criterion) of a suitable cell, it may also determine the cell priority of the cell reselection according to the first slice information corresponding to the MO traffic. In this way, the reselected target cell can provide better MO traffic-related communication services for the terminal.

In an embodiment, in a case where the target cell is determined based on a determination condition for a suitable cell, a condition that the cell priority of the cell reselection is determined according to the first slice information corresponding to the MO traffic may be added to the determination condition. In this way, it can be ensured that a target cell satisfying the determination condition of the suitable cell is reselected, and better MO traffic-related communication services can be provided for the terminal.

In an embodiment, the first frequency point supporting the first slice information includes a frequency point for which the terminal has a measurement result; and/or the first cell supporting the first slice information includes a cell for which the terminal has a measurement result.

For example, the first frequency point supporting the first slice information includes the frequency point for which the terminal has the measurement result, and does not include a frequency point for which the terminal has no measurement result. Thus, it can be ensured that the terminal has a measurement result for the first frequency point supporting the first slice information determined in a cell reselection process. In this way, information (such as priority) related to the first frequency point may be determined directly based on the measurement result without obtaining the measurement result. This facilitates the quick completion of the cell reselection and the effective use of the measurement result.

For example, the first cell supporting the first slice information includes the cell for which the terminal has the measurement result, and does not include a cell for which the terminal has no measurement result. Thus, it can be ensured that the terminal has a measurement result for the first cell supporting the first slice information determined in a cell reselection process. In this way, related information (such as priority) related to the first cell may be determined directly based on the measurement result without obtaining the measurement result. This facilitates quick completion of the cell reselection and effective use of the measurement result.

It should be noted that in a case where the cell reselection is performed according to the first slice information corresponding to the MO traffic and the cell satisfying a preset condition is reselected, the reselected cell may be accessed. However, in a case where the cell satisfying a preset condition is not reselected, a fallback operation may be performed. For example, it may fall back to the legacy slice-based cell reselection or legacy non-slice-based cell reselection. Or, any cell selection state may be entered.

The preset condition may include at least one of the following: the first slice information corresponding to the MO traffic is supported, the highest cell priority is achieved, or the cell satisfies the determination condition of the suitable cell.

FIG. 4 is a schematic flowchart of a method for cell reselection according to yet another embodiment of the present disclosure. The method for cell reselection may be performed by a terminal. As shown in FIG. 4, the method for cell reselection further includes the following step S401.

In step S401, performing the cell reselection according to first slice information corresponding to mobile originated traffic is stopped in a case where a fourth condition is satisfied.

It should be noted that the embodiment shown in FIG. 4 may be implemented independently or in combination with at least one another embodiment in the present disclosure, which may be selected as required and not limited by the present disclosure.

In an embodiment, the terminal may perform the cell reselection according to the first slice information corresponding to the MO traffic, or may stop performing the cell reselection according to the first slice information corresponding to the MO traffic.

For example, the terminal may determine whether the fourth condition is satisfied. In a case where the fourth condition is not satisfied, the performed cell reselection may be the cell reselection performed according to the first slice information corresponding to the MO traffic. In a case where the fourth condition is satisfied, performing the cell reselection according to the first slice information corresponding to the MO traffic may be stopped. The performed cell reselection is the cell reselection performed according to a legacy method for determining reselection priority.

In an embodiment, the fourth condition includes at least one of the following: slice information corresponding to the mobile originated traffic is changed; a service corresponding to the mobile originated traffic is interrupted; or a service corresponding to the mobile originated traffic is ended.

For example, in a case where the slice information corresponding to the MO traffic is changed, the slice information corresponding to the MO traffic needs to be re-determined. Thus, the terminal may stop performing the cell reselection according to the first slice information corresponding to the MO traffic.

For example, in a case where the service corresponding to the MO traffic is interrupted, the terminal temporarily does not need a service provided by a slice corresponding to the MO traffic. Thus, performing the cell reselection according to the first slice information corresponding to the MO traffic may be stopped.

For example, in a case where the service corresponding to the MO traffic is ended, the terminal ends a service provided by a slice corresponding to the MO traffic. Thus, performing the cell reselection according to the first slice information corresponding to the MO traffic may be stopped.

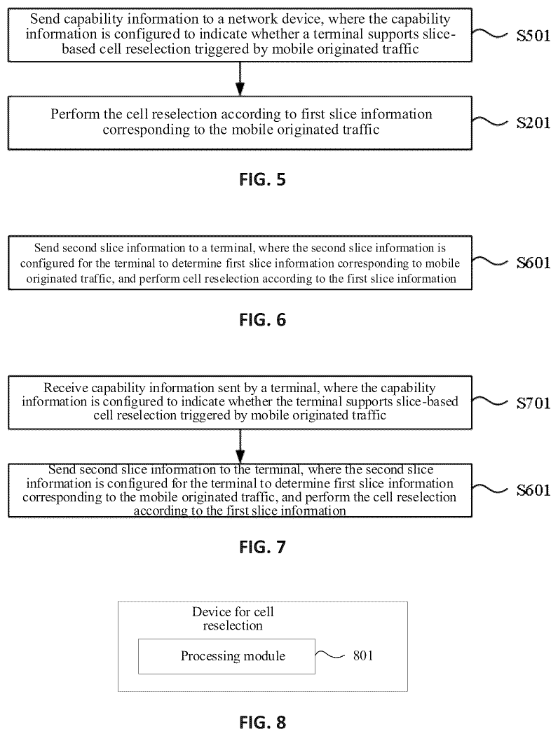

FIG. 5 is a schematic flowchart of a method for cell reselection according to still another embodiment of the present disclosure. The method for cell reselection may be performed by a terminal. As shown in FIG. 5, the method for cell reselection further includes the following step S501.

In step S501, capability information is sent to a network device. The capability information is configured to indicate whether a terminal supports slice-based cell reselection triggered by mobile originated traffic.

It should be noted that the embodiment shown in FIG. 5 may be implemented independently or in combination with at least one another embodiment in the present disclosure, which may be selected as required and not limited by the present disclosure.

In an embodiment, the terminal may send the capability information to the network device. Whether the terminal supports the slice-based cell reselection triggered by the MO traffic may be indicated by the capability information. In this way, the network device may make appropriate configurations for the terminal according to the capability information. For example, in a case where the network device determines that the terminal supports the slice-based cell reselection triggered by the MO traffic according to the capability information, all possible information related to S-NSSAI and an NSAG corresponding to the MO traffic may be provided for the terminal. In a case where the network device determines that the terminal does not support the slice-based cell reselection triggered by the MO traffic according to the capability information, all possible information related to S-NSSAI and an NSAG corresponding to the MO traffic does not need to be provided for the terminal.

FIG. 6 is a schematic flowchart of a method for cell reselection according to an embodiment of the present disclosure. The method for cell reselection in the embodiment may be performed by a network device. As shown in FIG. 6, the method for cell reselection may include the following step S601.

In step S601, second slice information is sent to a terminal. The second slice information is configured for the terminal to determine first slice information corresponding to mobile originated traffic, and the cell reselection is performed according to the first slice information.

In an embodiment, the network device may send the second slice information to the terminal. For example, the network device includes a core network device. The core network device may send the second slice information carried by NAS signaling to the terminal.

After an NAS of the terminal receives the second slice information, the NAS may provide the second slice information for an AS. Then, the AS may determine the first slice information corresponding to MO traffic according to the second slice information.

Further, when the terminal performs the cell reselection, the terminal may perform the cell reselection according to the first slice information corresponding to the MO traffic. Thus, a cell supporting the first slice information corresponding to the MO traffic is preferentially reselected, so as to ensure that the cell may support the first slice information corresponding to the MO traffic in a case where the terminal is camped on the reselected cell. In this way, the smooth operation of the MO traffic is ensured.

In an embodiment, the second slice information includes at least one of the following: at least one single-network slice selection assistance information corresponding to the mobile originated traffic; information related to a network slice access-stratum group (NSAG); or validity information.

In an embodiment, the information related to the network slice access-stratum group includes at least one of the following: a mapping relationship between the single-network slice selection assistance information and the network slice access-stratum group; or the priority of the network slice access-stratum group.

In an embodiment, after the network device sends the second slice information to the terminal through the NAS signaling, the NAS of the terminal may determine a correspondence relationship between services and the S-NSSAI according to a URSP configured by the NAS signaling, determine the S-NSSAI corresponding to the MO traffic according to the correspondence, and then determine the second slice information accordingly. For example, an NSAG to which the S-NSSAI belongs may be determined according to the mapping relationship between the S-NSSAI and the NSAG, and then priority of the NSAG may be determined. For example, the priority of the NSAG to which the S-NSSAI belongs may be determined according to a protocol agreement or priority of a plurality of NSAGs indicated by the network device.

In an embodiment, the validity information includes at least one of the following: validity area information of the single-network slice selection assistance information; validity time information of the single-network slice selection assistance information; validity area information of the information related to the network slice access-stratum group; or validity time information of the information related to the network slice access-stratum group.

The NAS of the terminal, after determining the S-NSSAI corresponding to the MO traffic and the NSAG to which the S-NSSAI belongs, may also determine validity information of the S-NSSAI and validity information of the NSAG. For example, the validity information of the S-NSSAI corresponding to the MO traffic may be determined according to the protocol agreement or the validity information of a plurality of S-NSSAI indicated by the network device. For example, the validity information of the NSAG to which the S-NSSAI belongs may be determined according to the protocol agreement or the validity information of the plurality of NSAGs indicated by the network device.

The validity information may include validity time or the validity area information. However, the validity information is not limited to the above two types, and is not limited by the present disclosure.

It should be noted that the S-NSSAI corresponding to the MO traffic belongs to at least one of the following: allowed NSSAI, alternative S-NSSAI, or partial allowed S-NSSAI. In a case of resource shortage of the S-NSSAI currently carrying the MO traffic, the S-NSSAI currently carrying the MO traffic may be replaced with the alternative S-NSSAI. The partial allowed S-NSSAI refers to S-NSSAI that is not uniformly supported in a range of an RA and is only supported in some TAs in the RA. Existing allowed NSSAI is S-NSSAI supported by all TAs in the RA.

In an embodiment, the first slice information includes at least one of the following: the network slice access-stratum group corresponding to the mobile originated traffic; the priority of the network slice access-stratum group; or tracking area information of the network slice access-stratum group.

In an embodiment, the information related to the network slice access-stratum group (NSAG) includes at least one of the following: information related to an NSAG to which the allowed NSSAI belongs, information related to an NSAG to which the alternative S-NSSAI belongs, or information related to an NSAG to which the partial allowed S-NSSAI belongs.

FIG. 7 is a schematic flowchart of a method for cell reselection according to another embodiment of the present disclosure. The method for cell reselection may be performed by a network device. As shown in FIG. 7, the method for cell reselection further includes the following step S701.

In step S701, capability information sent by a terminal is received. The capability information is configured to indicate whether the terminal supports slice-based cell reselection triggered by mobile originated traffic.

It should be noted that the embodiment shown in FIG. 7 may be implemented independently or in combination with at least one another embodiment in the present disclosure, which may be selected as required and not limited by the present disclosure.

In an embodiment, the network device may receive the capability information sent by the terminal. According to the capability information, the network device may determine whether the terminal supports the slice-based cell reselection triggered by the MO traffic. In this way, the network device may make appropriate configurations for the terminal according to the capability information. For example, in a case where the network device determines that the terminal supports the slice-based cell reselection triggered by the MO traffic according to the capability information, all possible information related to S-NSSAI and an NSAG corresponding to the MO traffic may be provided for the terminal. In a case where the network device determines that the terminal does not support the slice-based cell reselection triggered by the MO traffic according to the capability information, all possible information related to S-NSSAI and an NSAG corresponding to the MO traffic does not need to be provided for the terminal.

A method for cell reselection is further provided according to an embodiment of the present disclosure. The method is performed by a communication system. The communication system includes a terminal and a network device.

In an embodiment, the network device in the communication system may send second slice information to the terminal. The second slice information is configured for the terminal to determine first slice information corresponding to MO traffic, and perform the cell reselection according to the first slice information.

In an embodiment, the terminal in the communication system may perform the cell reselection according to the first slice information corresponding to the MO traffic.

It should be noted that reference is made to the description of related content in each previous embodiment for other content related to the embodiment, which will not be repeated here.

In correspondence to the embodiment of the method for cell reselection, the present disclosure further provides an embodiment of a device for cell reselection.

FIG. 8 is a schematic block diagram of a device for cell reselection according to an embodiment of the present disclosure. As shown in FIG. 8, the device for cell reselection includes:

a processing module 801 configured to perform the cell reselection according to first slice information corresponding to mobile originated traffic.

In an embodiment, the processing module is configured to perform the cell reselection according to the first slice information corresponding to the mobile originated traffic in a case where a first condition is satisfied.

In an embodiment, the first condition includes at least one of the following: a current serving cell does not support the first slice information; a measurement result for a frequency point supporting the first slice information exists; or a measurement result for a cell supporting the first slice information exists.

In an embodiment, the processing module is further configured to determine that the frequency point supports the first slice information in a case where the frequency point satisfies a second condition. The second condition includes at least one of the following: the frequency point has a capability to support the first slice information; or the frequency point has an available radio resource, and the radio resource is capable of supporting a quality of service requirement of a protocol data unit session associated with the first slice information.

In an embodiment, the processing module is further configured to determine that the cell supports the first slice information in a case where the cell satisfies a third condition. The third condition includes at least one of the following: the cell has a capability to support the first slice information; or the cell has an available radio resource, and the radio resource is capable of supporting a quality of service requirement of a protocol data unit session associated with the first slice information.

In an embodiment, the processing module is further configured to determine the first slice information according to second slice information provided by a non-access stratum.

In an embodiment, the second slice information includes at least one of the following: at least one single-network slice selection assistance information corresponding to the mobile originated traffic; information related to a network slice access-stratum group (NSAG); or validity information.

In an embodiment, the information related to the network slice access-stratum group includes at least one of the following: a mapping relationship between the single-network slice selection assistance information and the network slice access-stratum group; or a priority of the network slice access-stratum group.

In an embodiment, the validity information includes at least one of the following: validity area information of the single-network slice selection assistance information; validity time information of the single-network slice selection assistance information; validity area information of the information related to the network slice access-stratum group; or validity time information of the information related to the network slice access-stratum group.

In an embodiment, the cell reselection is performed according to the first slice information corresponding to the mobile originated traffic through at least one of the following: determining reselection priority of the cell reselection according to the first slice information corresponding to the mobile originated traffic; determining a candidate cell of the cell reselection according to the first slice information corresponding to the mobile originated traffic; or determining a target cell of the cell reselection according to the first slice information corresponding to the mobile originated traffic.

In an embodiment, the reselection priority of the cell reselection is determined according to the first slice information corresponding to the mobile originated traffic through at least one of the following: determining that a priority of a first frequency point is higher than a priority of a second frequency point, where the first frequency point is a frequency point that supports the first slice information, and the second frequency point is a frequency point that does not support the first slice information; or determining that a priority of a first cell is higher than a priority of a second cell, where the first cell is a cell that supports the first slice information, and the second cell is a cell that does not support the first slice information.

In an embodiment, determining the candidate cell of the cell reselection according to the first slice information corresponding to the mobile originated traffic includes at least one of the following: determining a first frequency point as a candidate frequency point of the cell reselection, where the first frequency point is a frequency point that supports the first slice information; or determining a first cell as the candidate cell of the cell reselection. The first cell is a cell that supports the first slice information.

In an embodiment, the processing module is configured to perform at least one of the following: determining a first frequency point as a target frequency point of the cell reselection, where the first frequency point is a frequency point that supports the first slice information; or determining a first cell as the target cell of the cell reselection, where the first cell is a cell that supports the first slice information.

In an embodiment, the first frequency point supporting the first slice information includes a frequency point for which the terminal has a measurement result; and/or the first cell supporting the first slice information includes a cell for which the terminal has a measurement result.

In an embodiment, the first slice information includes at least one of the following: the network slice access-stratum group corresponding to the mobile originated traffic; the priority of the network slice access-stratum group; or tracking area information of the network slice access-stratum group.

In an embodiment, the processing module is further configured to stop performing the cell reselection according to the first slice information corresponding to the mobile originated traffic in a case where a fourth condition is satisfied In an embodiment, the fourth condition includes at least one of the following: slice information corresponding to the mobile originated traffic is changed; a service corresponding to the mobile originated traffic is interrupted; or a service corresponding to the mobile originated traffic is ended.

In an embodiment, the device further includes a sending module configured to send capability information to a network device. The capability information is configured to indicate whether the terminal supports slice-based cell reselection triggered by the mobile originated traffic.

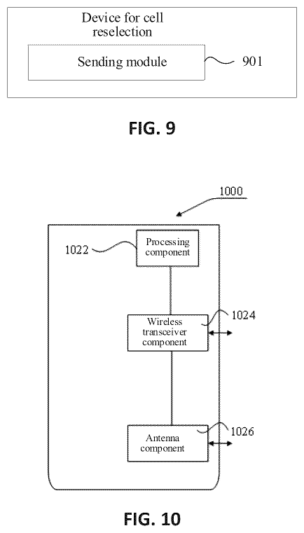

FIG. 9 is a schematic block diagram of a device for cell reselection according to an embodiment of the present disclosure. As shown in FIG. 9, the device for cell reselection includes:

a sending module 901, configured to send second slice information to a terminal, where the second slice information is configured for the terminal to determine first slice information corresponding to mobile originated traffic, and perform the cell reselection according to the first slice information.

In an embodiment, the second slice information includes at least one of the following: at least one single-network slice selection assistance information corresponding to the mobile originated traffic; information related to a network slice access-stratum group (NSAG); or validity information.

In an embodiment, the information related to the network slice access-stratum group includes at least one of the following: a mapping relationship between the single-network slice selection assistance information and the network slice access-stratum group; or a priority of the network slice access-stratum group.

In an embodiment, the validity information includes at least one of the following: validity area information of the single-network slice selection assistance information; validity time information of the single-network slice selection assistance information; validity area information of the information related to the network slice access-stratum group; or validity time information of the information related to the network slice access-stratum group.

In an embodiment, the first slice information includes at least one of the following: the network slice access-stratum group corresponding to the mobile originated traffic; the priority of the network slice access-stratum group; or tracking area information of the network slice access-stratum group.

In an embodiment, the device further includes a receiving module, configured to receive capability information sent by a terminal, where the capability information is configured to indicate whether the terminal supports slice-based cell reselection triggered by the mobile originated traffic.

The device embodiment substantially corresponds to the method embodiment, so reference may be made to part of the description of the method embodiment for relevant content. The device embodiment is merely illustrative. Modules described as separate components may be physically separated or not, and components displayed as modules may be physical modules or not. That is, the components may be located at one place or distributed on a plurality of network modules. Some or all modules may be selected according to actual needs to achieve the objective of the solution of the embodiment. Those of ordinary skill in the art may perform understanding and implementation without making the inventive effort.

An embodiment of the present disclosure further provides a communication system. The communication system includes a terminal and a network device. The terminal is configured to implement the method for cell reselection performed by the terminal according to any one of the embodiments. The network device is configured to implement the method for cell reselection performed by the network device according to any one of the embodiments.

An embodiment of the present disclosure further provides a communication device. The communication device includes a processor; and a memory configured to store a computer program. The computer program, when executed by the processor, implements the method for cell reselection performed by a terminal according to any one of the embodiments.

An embodiment of the present disclosure further provides a communication device. The communication device includes a processor; and a memory configured to store a computer program. The computer program, when executed by the processor, implements the method for cell reselection performed by a network device according to any one of the embodiments.

An embodiment of the present disclosure further provides a non-transitory computer-readable storage medium configured to store a computer program. The computer program, when executed by a processor, implements the method for cell reselection performed by a terminal according to any one of the embodiments.

An embodiment of the present disclosure further provides a non-transitory computer-readable storage medium configured to store a computer program. The computer program, when executed by a processor, implements the method for cell reselection performed by a network device according to any one of the embodiments.

As shown in FIG. 10, FIG. 10 is a schematic block diagram of a device 1000 for cell reselection according to an embodiment of the present disclosure. The device 1000 may be a base station. With reference to FIG. 10, the device 1000 includes a processing component 1022, a wireless transceiver component 1024, an antenna component 1026, and a signal processing part unique to a radio interface. The processing component 1022 may further include one or more processors. One of the processors in the processing component 1022 may be configured to implement the method for cell reselection performed by the network device according to any one of the embodiments.

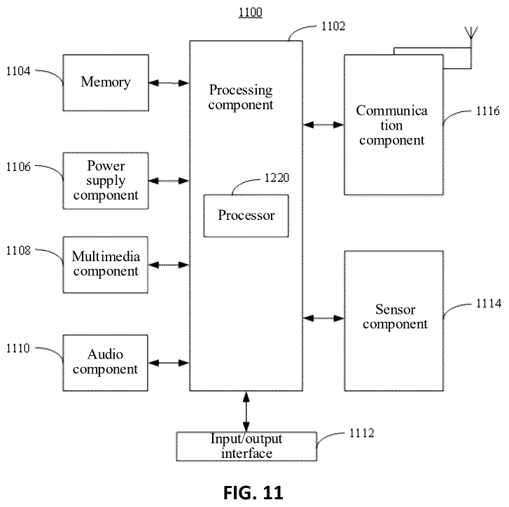

FIG. 11 is a schematic block diagram of a device 1100 for cell reselection according to an embodiment of the present disclosure. For example, the device1100 may be a terminal, for example, a mobile phone, a computer, a digital broadcast terminal, a messaging device, a game console, a tablet device, a medical device, a fitness device, a personal digital assistant, etc.

With reference to FIG. 11, the device 1100 may include one or more of the following components: a processing component 1102, a memory 1104, a power supply component 1106, a multimedia component 1108, an audio component 1110, an input/output (I/O) interface 1112, a sensor component 1114, and a communication component 1116.

The processing component 1102 generally controls all operations of the device 1100, such as operations associated with display, telephone call, data communication, a camera operation, and a recording operation. The processing component 1102 may include one or more processors 1120 to execute instructions, so as to implement all or some steps of the method for cell reselection performed by the terminal according to any one of the embodiments. In addition, the processing component 1102 may include one or more modules to facilitate interaction between the processing component 1102 and other components. For example, the processing component 1102 may include a multimedia module to facilitate interaction between the multimedia component 1108 and the processing component 1102.

The memory 1104 is configured to store various types of data, so as to support the operations on the device 1100. Instances of the data include instructions for any application or method operating on the device 1100, contact data, phone book data, a message, an image, a video, etc.

The power supply component 1106 supplies power to various components of the device 1100. The power supply component 1106 may include a power management system, one or more power supplies, and other components associated with generating, managing and distributing power for the device 1100.

The multimedia component 1108 includes a screen that provides one output interface between the device 1100 and a user. In some embodiments, the screen may include a liquid crystal display (LCD) and a touch panel (TP). In a case where the screen includes the touch panel, the screen may be implemented as a touch screen to receive an input signal from the user.

The audio component 1110 is configured to output and/or input an audio signal. For example, the audio component 1110 includes a microphone (MIC). The microphone is configured to receive an external audio signal in a case where the device 1100 is in operation modes such as a call mode, a recording mode, and a speech identification mode. The received audio signal may be further stored in the memory 1104 or sent via the communication component 1116. In some embodiments, the audio component 1110 further includes a speaker configured to output an audio signal.

The I/O interface 1112 provides an interface between the processing component 1102 and a peripheral interface module. The peripheral interface module may be a keyboard, a click wheel, a button, etc. The buttons may include, but are not limited to, a home button, a volume button, a start button, and a lock button.

The sensor component 1114 includes one or more sensors configured to provide various aspects of state assessment for the device 1100.

The communication component 1116 is configured to facilitate wired or wireless communication between the device 1100 and other devices. The device 1100 may access wireless networks based on a communication standard, such as WiFi, 2G, 3G, 4G LTE, 5G NR, or their combinations. In one example, the communication component 1116 receives a broadcast signal or broadcast-related information from an external broadcast management system via a broadcast channel. In one example, the communication component 1116 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, or other technologies.

In an example, the device 1100 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic elements, thus performing the method for cell reselection performed by the terminal according to any one of the embodiments.

An example further provides a non-transitory computer-readable storage medium including instructions, such as the memory 1104, including instructions. The instructions may be executed by the processor 1120 of the device 1100 to complete the method for cell reselection performed by the terminal according to any one of the embodiments. For example, the non-transitory computer-readable storage medium may be a read-only memory (ROM), a random access memory (RAM), a compact disc read-only memory (CD-ROM), a magnetic tape, a floppy disk, an optical data storage device, etc.

Those skilled in the art could easily conceive of other implementation solutions of the present disclosure upon consideration of the description and the present disclosure disclosed here. The present disclosure is intended to cover any variations, uses, or adaptive changes of the present disclosure. These variations, uses, or adaptive changes follow general principles of the present disclosure and include common general knowledge or conventional technical means not disclosed in the present disclosure in the art. The description and the embodiments are regarded as merely illustrative, and the true scope and spirit of the present disclosure are indicated by the following claims.

It should be understood that the present disclosure is not limited to a precise structure described above and illustrated in the accompanying drawings, and may be subjected to various modifications and changes without departing from the scope. The scope of the present disclosure is limited merely by the appended claims.

1. A method for cell reselection, performed by a terminal, the method comprising:
performing the cell reselection according to first slice information corresponding to mobile originated traffic.

2. The method according to claim 1, wherein performing the cell reselection according to the first slice information corresponding to the mobile originated traffic comprises:
performing the cell reselection according to the first slice information corresponding to the mobile originated traffic, in a case where a first condition is satisfied.

3. The method according to claim 2, wherein the first condition comprises at least one of the following:
a current serving cell not supporting the first slice information;
a measurement result for a frequency point supporting the first slice information; or a measurement result for a cell supporting the first slice information.

4. The method according to claim 3, wherein the method further comprises:
determining that the frequency point supports the first slice information in a case where the frequency point satisfies a second condition, wherein the second condition comprises at least one of the following:
the frequency point having a capability to support the first slice information; or
the frequency point having an available radio resource, wherein the radio resource is capable of supporting a quality of service requirement of a protocol data unit session associated with the first slice information; or
wherein the method further comprises:
determining that the cell supports the first slice information in a case where the cell satisfies a third condition, wherein the third condition comprises at least one of the following:
the cell having a capability to support the first slice information; or the cell having an available radio resource, wherein the radio resource is capable of supporting a quality of service requirement of a protocol data unit session associated with the first slice information.

5. (canceled)

6. The method according to claim 1, further comprising:
determining the first slice information according to second slice information provided by a non-access stratum.

7. The method according to claim 6, wherein the second slice information comprises at least one of the following:
at least one single-network slice selection assistance information corresponding to the mobile originated traffic;
information related to a network slice access-stratum group (NSAG); or validity information.

8. The method according to claim 7, wherein the information related to the network slice access-stratum group comprises at least one of the following:
a mapping relationship between single-network slice selection assistance information and the network slice access-stratum group; or
a priority of the network slice access-stratum group.

9. The method according to claim 7, wherein the validity information comprises at least one of the following:
validity area information of the single-network slice selection assistance information;
validity time information of the single-network slice selection assistance information;
validity area information of the information related to the network slice access-stratum group; or
validity time information of the information related to the network slice access-stratum group.

10. The method according to claim 1, wherein performing the cell reselection according to the first slice information corresponding to the mobile originated traffic comprises at least one of the following:
determining a reselection priority of the cell reselection according to the first slice information corresponding to the mobile originated traffic;
determining a candidate cell of the cell reselection according to the first slice information corresponding to the mobile originated traffic; or
determining a target cell of the cell reselection according to the first slice information corresponding to the mobile originated traffic.

11. The method according to claim 10, wherein determining the reselection priority of the cell reselection according to the first slice information corresponding to the mobile originated traffic comprises at least one of the following:
determining that a priority of a first frequency point is higher than a priority of a second frequency point, wherein the first frequency point is a frequency point that supports the first slice information, and the second frequency point is a frequency point that does not support the first slice information; or
determining that a priority of a first cell is higher than a priority of a second cell, wherein the first cell is a cell that supports the first slice information, and the second cell is a cell that does not support the first slice information.

12. The method according to claim 10, wherein determining the candidate cell of the cell reselection according to the first slice information corresponding to the mobile originated traffic comprises at least one of the following:
determining a first frequency point as a candidate frequency point of the cell reselection, wherein the first frequency point is a frequency point that supports the first slice information; or
determining a first cell as the candidate cell of the cell reselection, wherein the first cell is a cell that supports the first slice information; or
wherein determining the target cell of the cell reselection according to the first slice information corresponding to the mobile originated traffic comprises at least one of the following:
determining a first frequency point as a target frequency point of the cell reselection, wherein the first frequency point is a frequency point that supports the first slice information; or
determining a first cell as the target cell of the cell reselection, wherein the first cell is a cell that supports the first slice information.

13. (canceled)

14. The method according to claim 11, wherein
the first frequency point supporting the first slice information comprises a frequency point for which the terminal has a measurement result; and/or
the first cell supporting the first slice information comprises a cell for which the terminal has a measurement result.

15. The method according to claim 1, wherein the first slice information comprises at least one of the following:
a network slice access-stratum group corresponding to the mobile originated traffic;
a priority of the network slice access-stratum group; or
tracking area information of the network slice access-stratum group.

16. The method according to claim 1, wherein the method comprises:
stopping performing the cell reselection according to the first slice information corresponding to the mobile originated traffic, in a case where a fourth condition is satisfied; or
wherein the method further comprises:
sending capability information to a network device, wherein the capability information is configured to indicate whether the terminal supports slice-based cell reselection triggered by the mobile originated traffic.

17. The method according to claim 16, wherein the fourth condition comprises at least one of the following:
slice information corresponding to the mobile originated traffic is changed;
a service corresponding to the mobile originated traffic is interrupted; or
a service corresponding to the mobile originated traffic is ended.

18. (canceled)

19. A method for cell reselection, performed by a network device, the method comprising:
sending second slice information to a terminal, wherein the second slice information is configured for the terminal to determine first slice information corresponding to mobile originated traffic, and performing the cell reselection according to the first slice information.

20-22. (canceled)

23. The method according to claim 19, wherein the first slice information comprises at least one of the following:
a network slice access-stratum group corresponding to the mobile originated traffic;
a priority of the network slice access-stratum group; or
tracking area information of the network slice access-stratum group.

24. The method according to claim 19, further comprising:
receiving capability information sent by the terminal, wherein the capability information is configured to indicate whether the terminal supports slice-based cell reselection triggered by the mobile originated traffic.

25-27. (canceled)

28. A communication device, comprising:
one or more processors; and
a memory configured to store a computer program, wherein
the computer program, when collectively executed by the one or more_processors, causes the communication device to:
perform cell reselection according to first slice information corresponding to mobile originated trafficthe

29. (canceled)

30. A non-transitory_computer-readable storage medium storing a computer program, wherein the computer program, when collectively executed by one or more processors, causes the one or more processors to perform the method for cell reselection according to claim 1.

31. (canceled)
